(19) United States
(12) Patent Application Publication
(10) Pub. No.: US 2013/0339060 A1
(43) Pub. Date: Dec. 19, 2013

(54) METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS

(71) Applicants: Conor Delaney, Shaker Heights, OH (US); Jonah Stulberg, Shaker Heights, OH (US)

(72) Inventors: Conor Delaney, Shaker Heights, OH (US); Jonah Stulberg, Shaker Heights, OH (US)

(73) Assignee: UNIVERSITY HOSPITALS OF CLEVELAND, Cleveland, OH (US)

(21) Appl. No.: 13/985,279

(22) PCT Filed: Feb. 16, 2012
(86) PCT No.: PCT/US12/25421

§ 371 Date: Aug. 13, 2013

Related U.S. Application Data
(60) Provisional application No. 61/443,853, filed on Feb. 17, 2011.

(51) Int. Cl. G06Q 50/24; G06Q 10/06

(52) U.S. Cl. CPC G06Q 50/24; G06Q 10/0637
USPC 705/3

(57) ABSTRACT

A system and method for the analysis of one or more patient encounters from one or more healthcare related information systems of a healthcare organization are disclosed. The system and method include a data processing system, which provides a graphical user interface which accepts a query regarding the patient encounters, which receives data in response to the query from the one or more healthcare related information systems about a plurality of pre-selected objects concerning the one or more patient encounters, and which arranges the data according to a data model which sets relations between the pre-selected objects. The system and method also employ the relations between the pre-selected objects to provide a report to the accepted query, and output the report.

### CROSS REFERENCE TO RELATED APPLICATIONS

This application claims the benefit of U.S. provisional patent application Ser. No. 61/443,853 filed 17 Feb. 2011 and PCT application serial no. PCT/US2012/025421 filed 16 Feb. 2012 entitled “METHOD AND SYSTEM FOR EXTRACTION AND ANALYSIS OF INPATIENT AND OUTPATIENT ENCOUNTERS FROM ONE OR MORE HEALTHCARE RELATED INFORMATION SYSTEMS”, the entireties of these applications are incorporated herein by reference.

The present disclosure is directed to health information systems, and in particularly to methods and systems for extraction and analysis of patient encounters from one or more healthcare related information systems.

Healthcare organizations, such as hospitals and clinics, have at their disposal vast amounts of data through the utilization of a number of healthcare information systems, e.g., for billing, administration, resource scheduling and documentation, patient records, etc. Given that such healthcare organizations face strong pressures to reduce costs while increasing the quality of services delivered, analysis of such available data can lead to greater efficiency, better decision-making, improved patient care, and lower costs. However, the challenge is being able to extract relevant knowledge from such data which can help in the decision-making process.

It is against the above background, that disclosed hereinafter are various embodiments of the present invention, which include a method and system for the extraction and analysis of patient encounters from one or more healthcare related information systems, such as for physician billing, organization billing, resource scheduling and documentation, healthcare administration, patient records, and the like, on a given problem in order to help with the decision-making process of healthcare workers and managers to improve patient care and outcomes, and gain greater efficiencies in the use of resources and reduce costs.

In one embodiment, a method for extraction and analysis of patient encounters from one or more healthcare related information systems of a healthcare organization is disclosed. The method comprises providing a data processing system, which extracts data from the one or more healthcare related information systems. The data model in the system establishes a relationship between pre-selected objects and provides a graphical user interface for presentation of the data.

In another embodiment, a data processing system for extraction and analysis of patient encounters from one or more healthcare related information systems of a healthcare organization is disclosed. The system comprises an importer component which receives data from the one or more healthcare related information systems about a plurality of pre-selected objects concerning the inpatient and outpatient encounters of the healthcare organization, and arranges said data according to a data model which sets relations between the pre-selected objects; a database component which receives the arranged data from the importer component and stores the arranged data in a database; and a graphical user interface which accepts a query on the arranged data, wherein the database component employs the relations between the pre-selected objects to provide a report to the accepted query, and outputs the report to the graphical user interface.

The following description and the annexed drawings set forth in detail certain illustrative aspect embodiments of the subject invention. These aspect embodiments are indicative, however, of but a few of the various ways in which the principles of the subject invention may be implemented. Other advantages and novel features of the invention will become apparent from the following detailed description of the invention when considered in conjunction with the drawings.

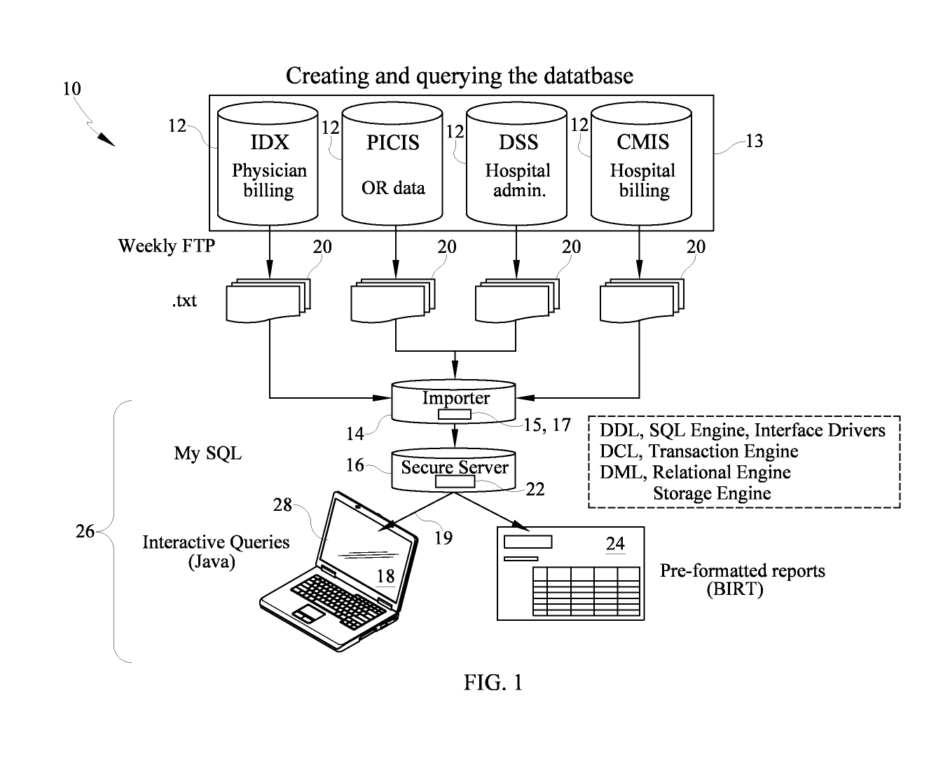

FIG. 1 is a block diagram of one example of a data processing system according to an embodiment for creating and querying a database thereof;

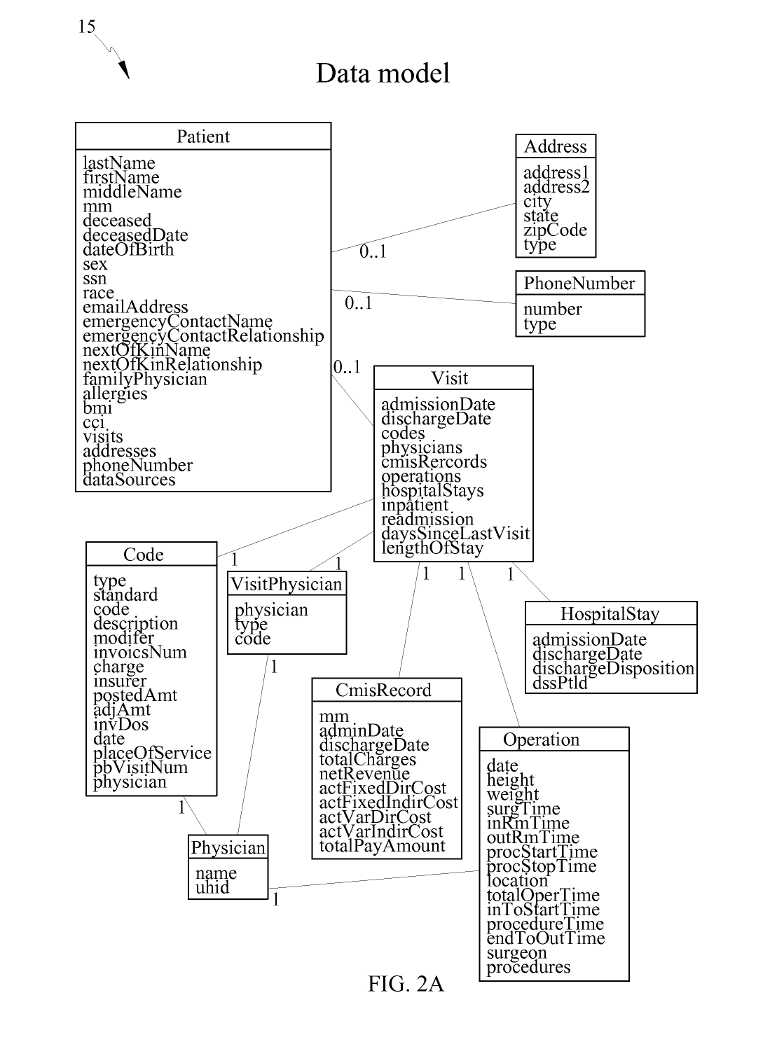

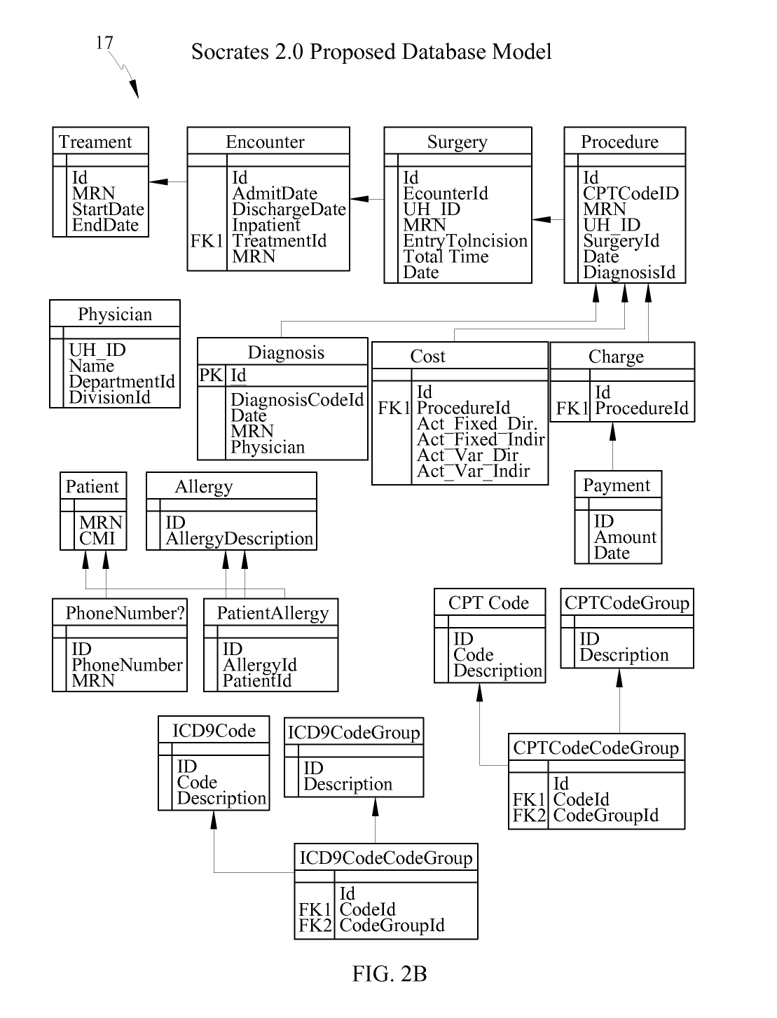

FIGS. 2A-B are schematic diagrams of examples of data models according to an embodiment;

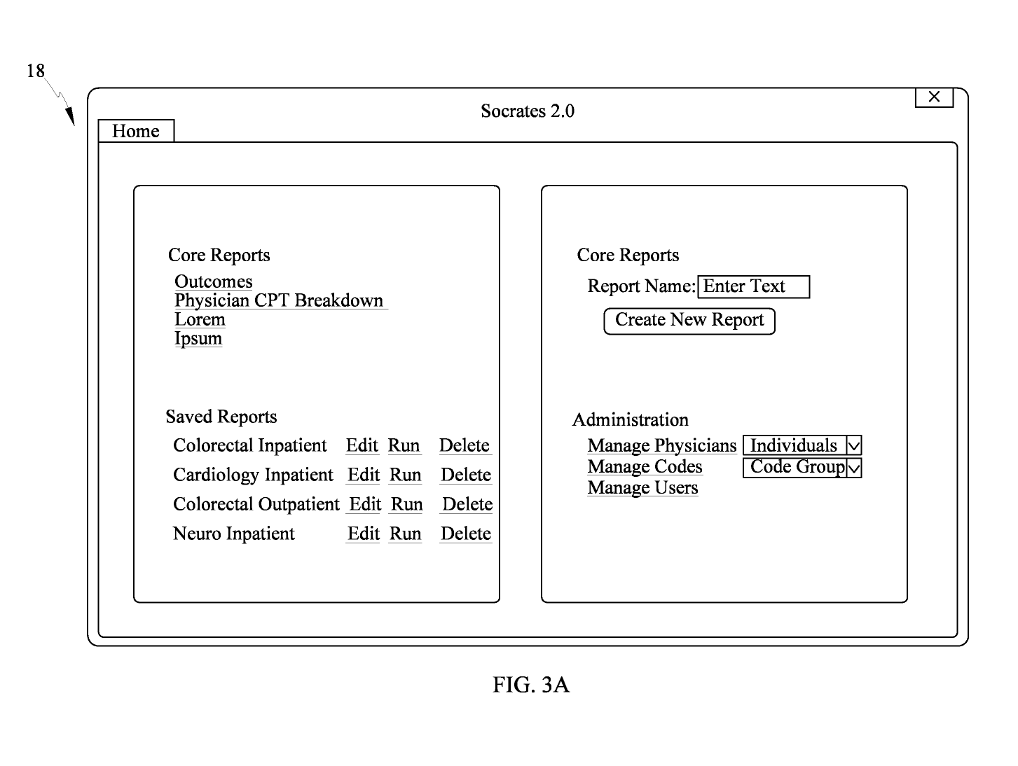

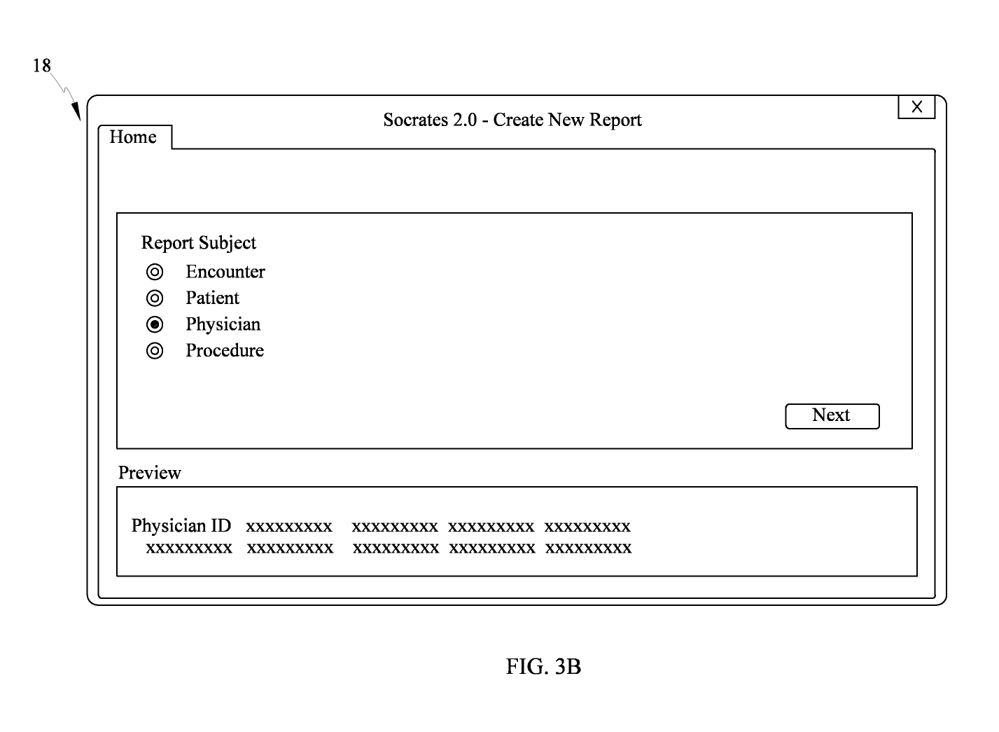

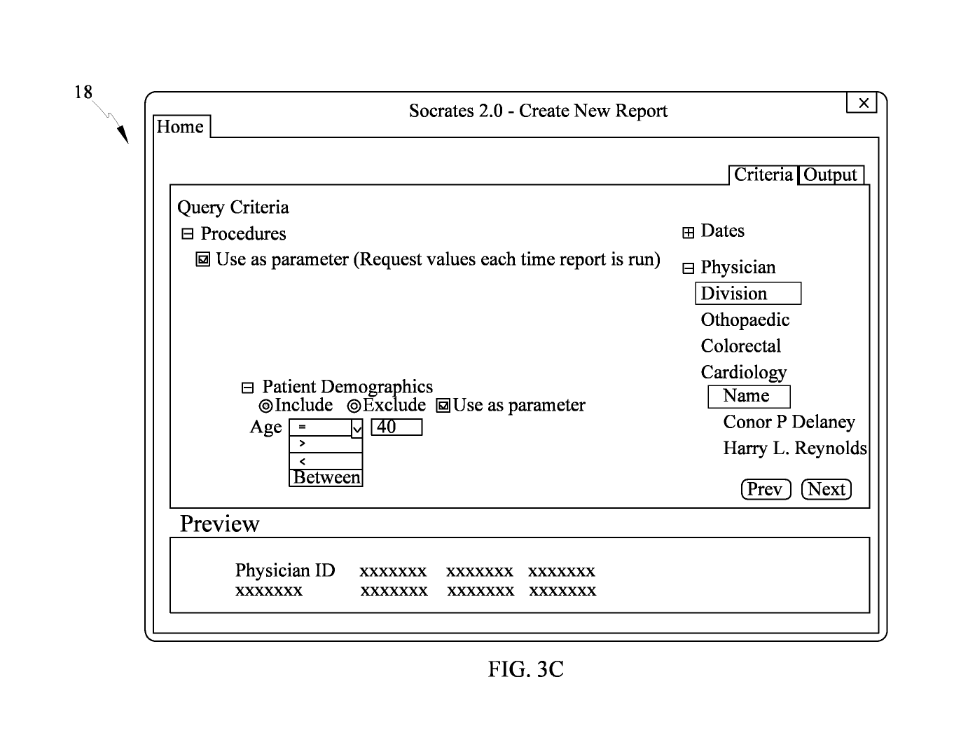

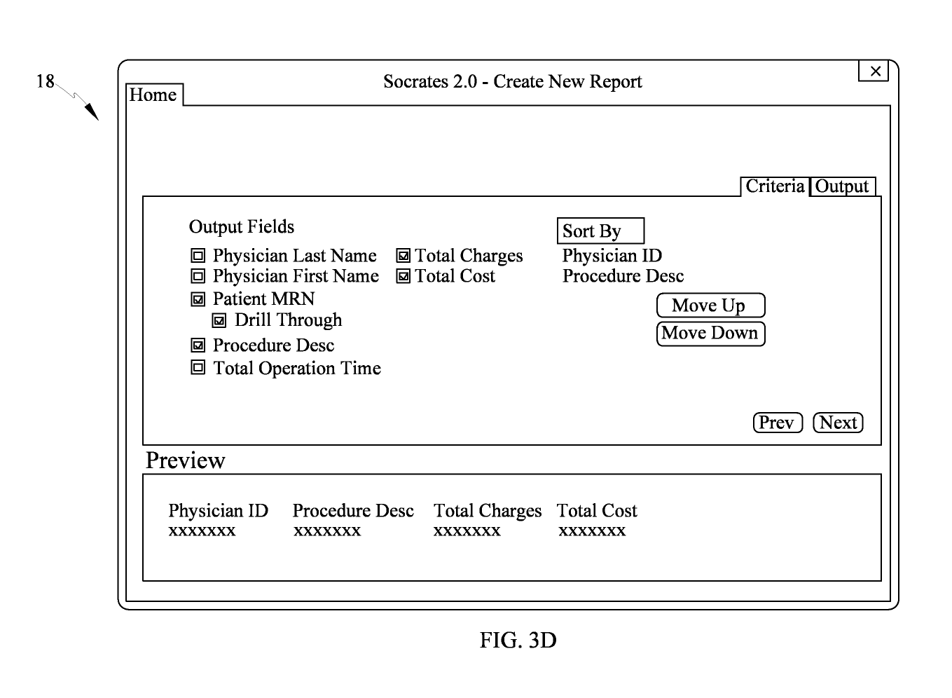

FIGS. 3A-D are a depiction of an example of a graphical user interface which enables interactive queries in the systems of FIGS. 2A-B,

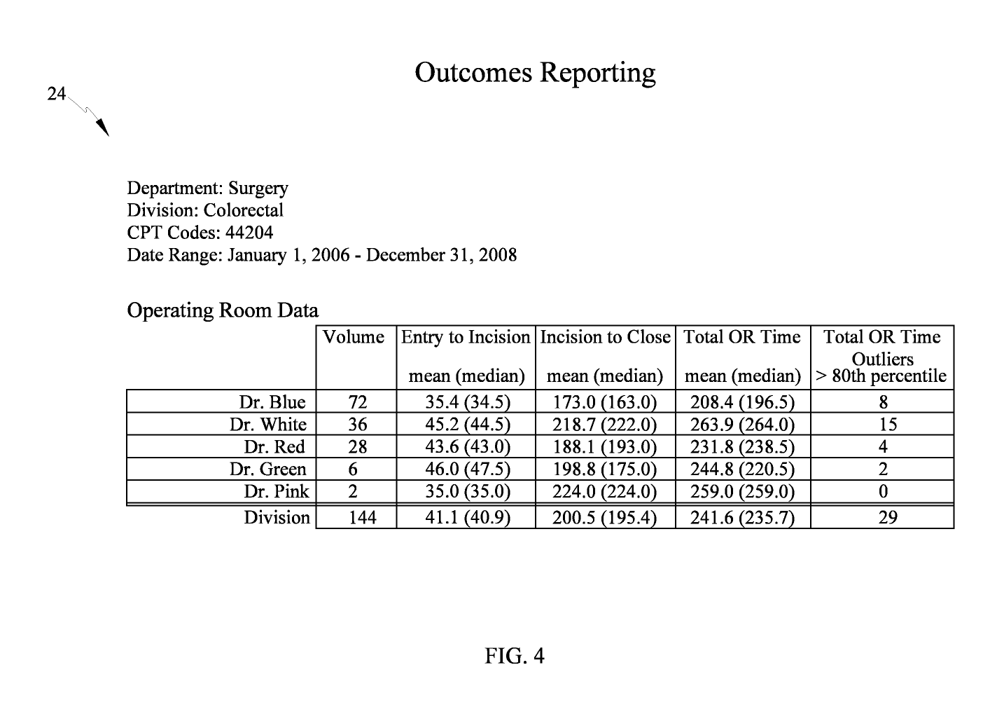

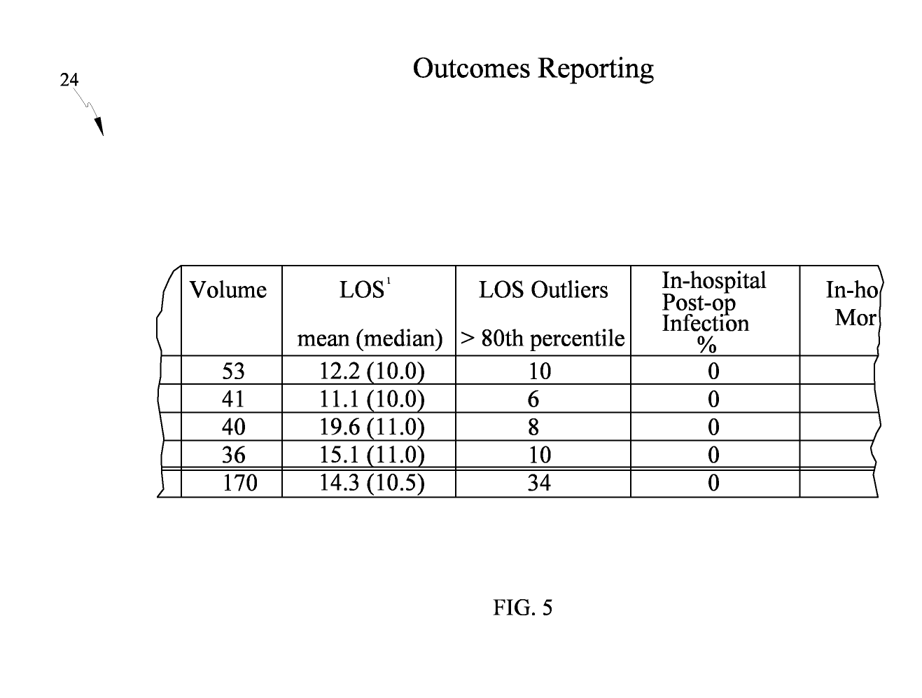

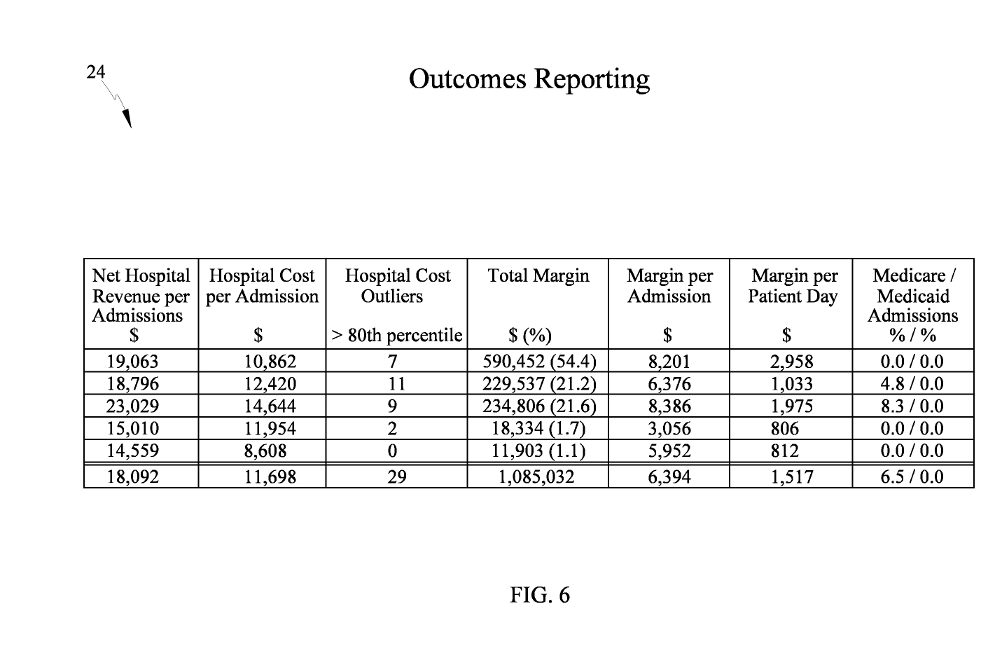

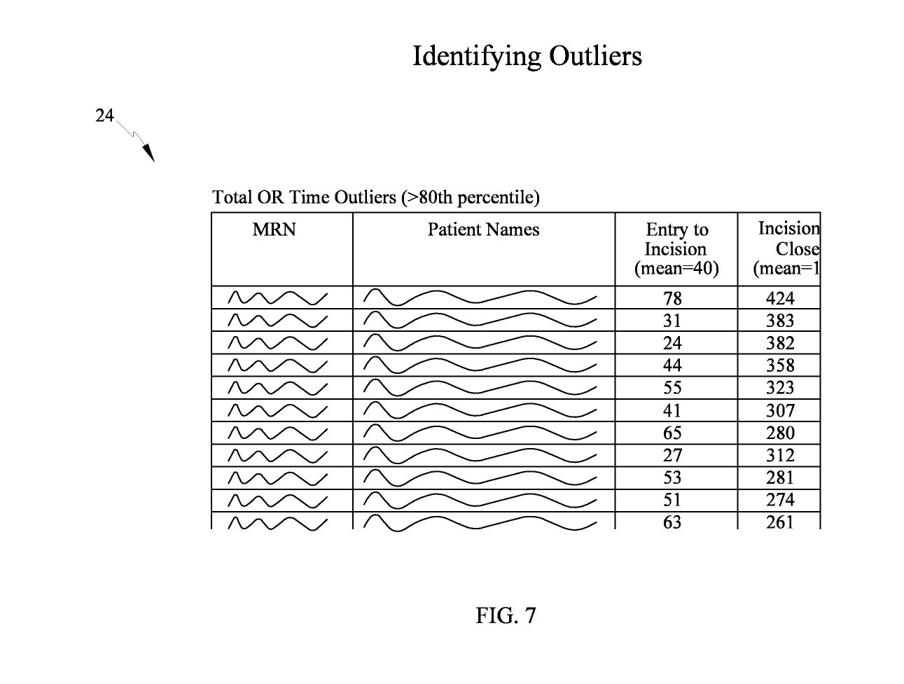

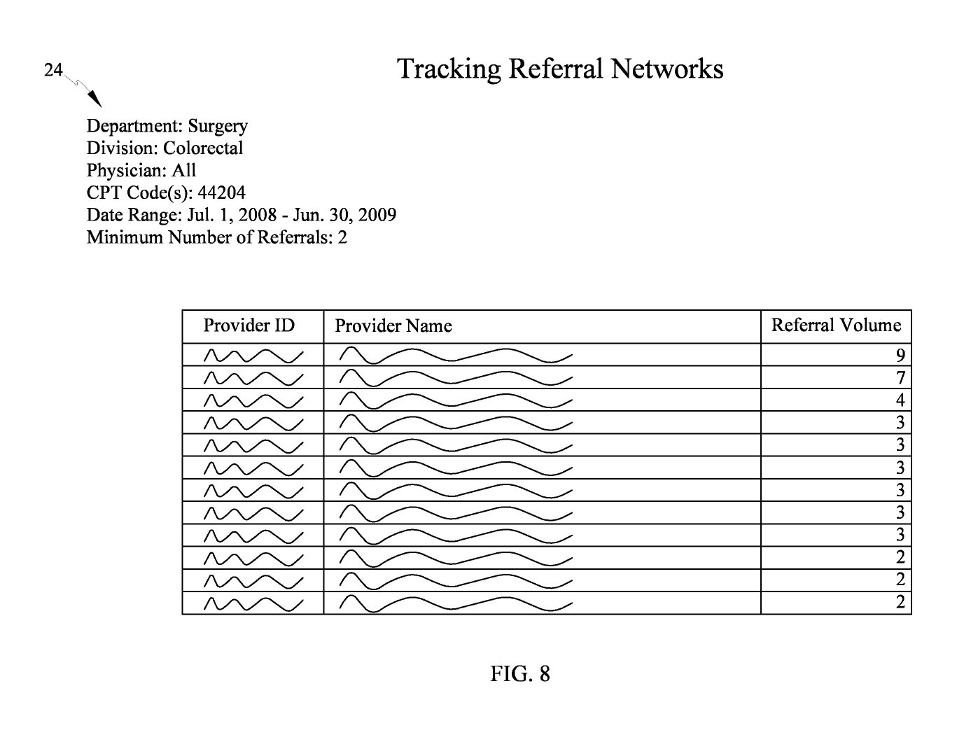

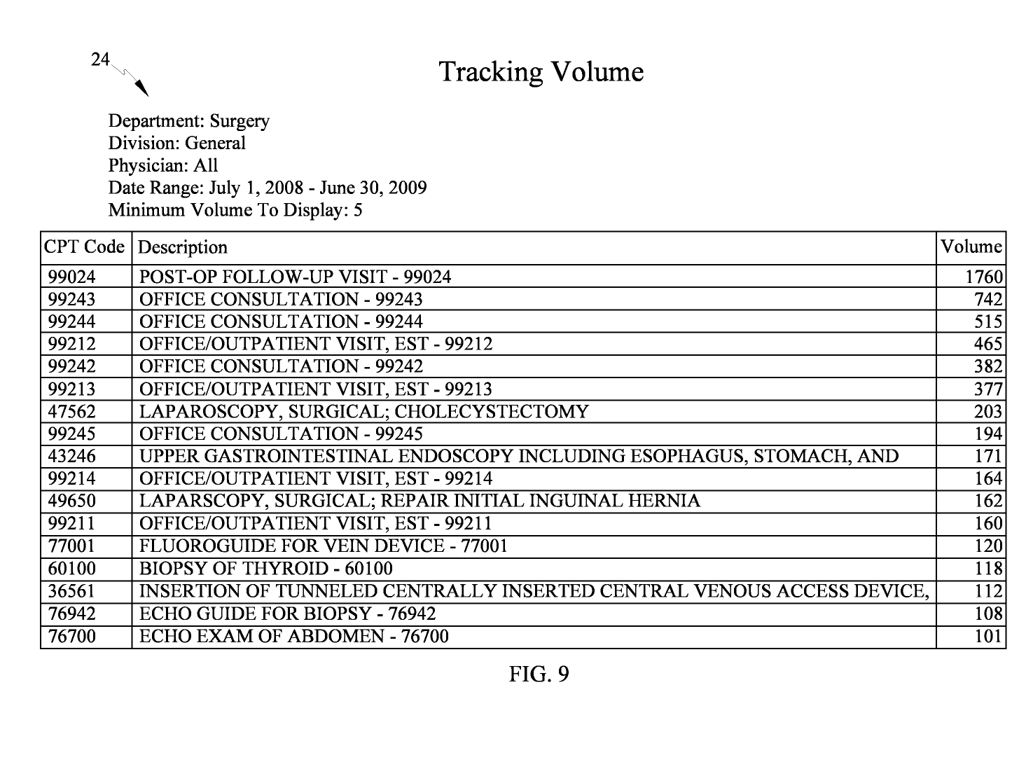

FIGS. 4-9 are depictions of various examples of reports provided by the systems of FIGS. 2A-B;

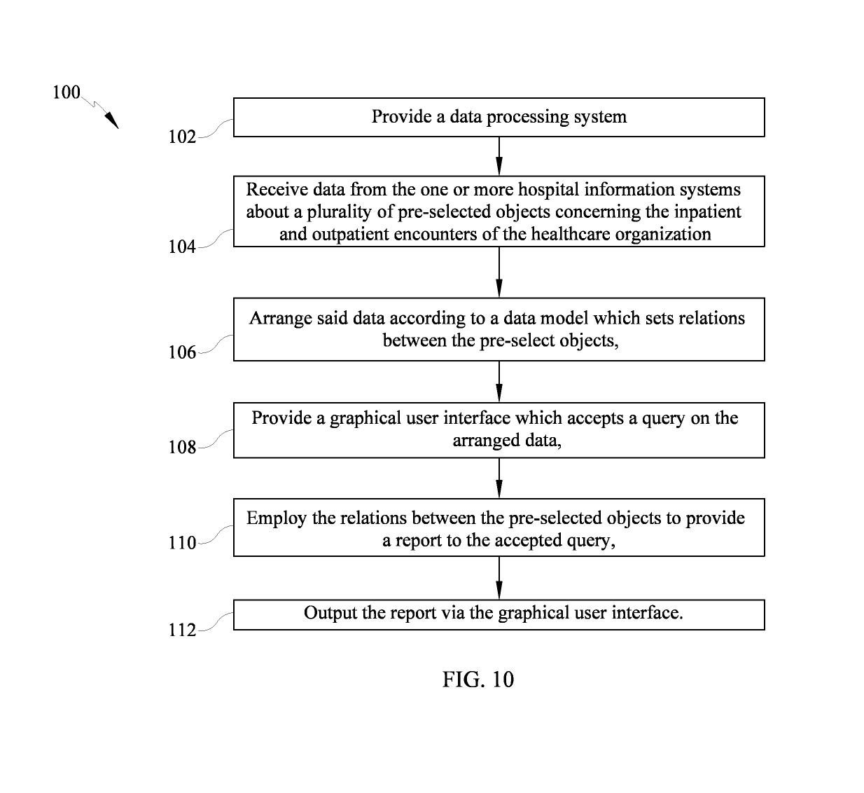

FIG. 10 is a flowchart representing one example of a method of extracting and analyzing of inpatient and outpatient encounters from one or more healthcare related information systems;

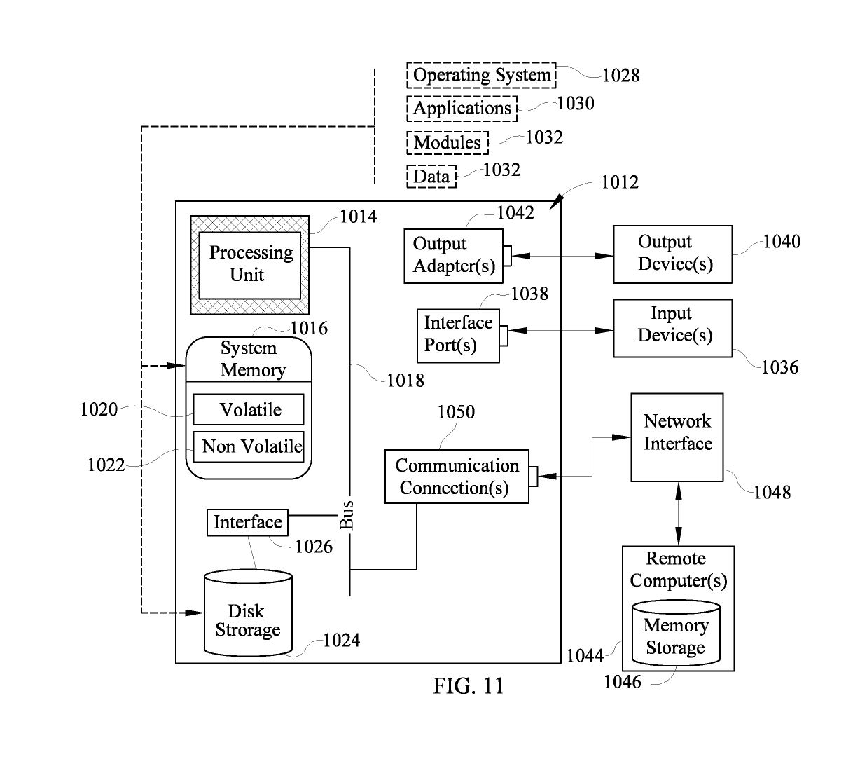

FIG. 11 illustrates an exemplary computing architecture; and

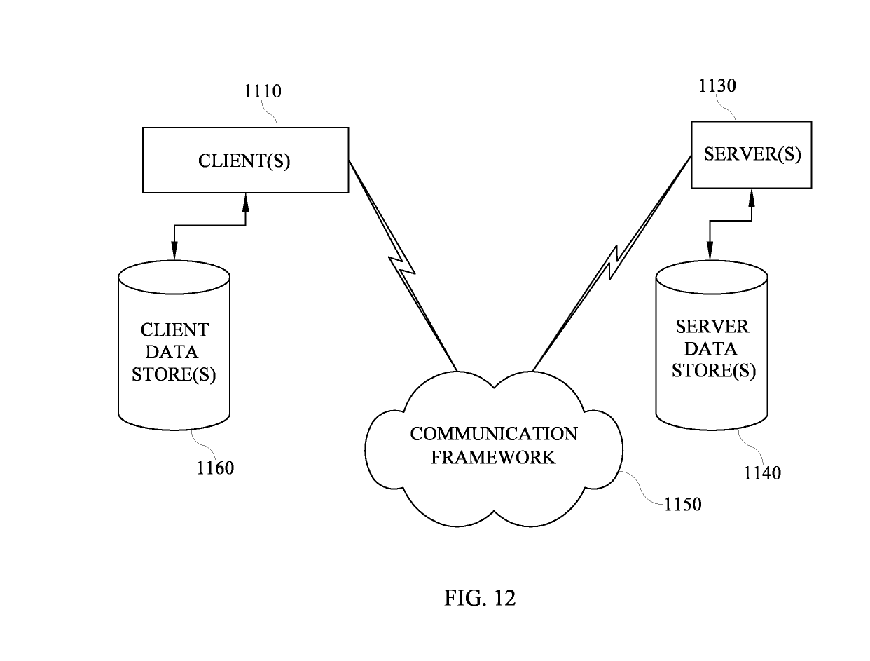

FIG. 12 illustrates an exemplary networking environment.

It is to be appreciated that various embodiments of the present invention relate to a computer-based decision support and knowledge discovery technology for the healthcare industry. Some embodiments include a method and system for the extraction and analysis of patient encounters recorded in a healthcare organization's existing internal and external data sources, such as practice management systems (PMS), health information systems (HIS), electronic medical records systems (EMRs), lab systems, medical reference systems, and existing decision support systems. Such PMS, HIS, EMR, lab systems, medical reference systems and existing decision support systems are well known to physicians, nurses, and others in the healthcare environment. Such data processing includes any computational processes that goes through predefined sequences of operations on the data and converts such data into useful information.

It should be understood that the disclosed embodiments are not limited to a particular technology, computer platform, particular processor, particular high-level programming language or Web service. Additionally, a computer system on which the various embodiments of the present invention is implemented may be any multiprocessor computer system and may include multiple computers connected over a wired and/or wireless computer network, such as a LAN, WAN, the Internet, and the like.

With reference to FIG. 1, the various components of a system 10 for extraction and analysis of patient encounters from one or more healthcare related information systems 12 of a healthcare organization 13 is depicted schematically. The system 10 comprises an importer component 14, a database server 16, and a graphical user interface 18. The importer component 14 receives data extracts 20 from the one or more existing systems 12, which are also referred to collectively as data sources. The importer component 14 arranges the received data according to a data model 15 or data model 17, which defines relationships between pre-selected objects provided in the received data, such as depicted by FIGS. 2A-B, and provides the arranged data to the database server 16, which stores the arranged data in a database 22 thereof. The graphical user interface 18 accepts a query on the arranged data and communicates the accepted query to the database server 16, such as via a wired and/or wireless network 19. The network 19 may be a private network, a public network, and a virtual private network. The database server 16 employs the relations between the pre-selected objects, as depicted in FIG. 2, on the arranged data in the database 22 to provide a report 24 to the accepted query, and outputs the report 24 via the graphical user interface 18.

It is to be appreciated that the database server 16 contains the relational database management system (RDBMS) which provides storage, access, security, querying and updating to data contained in the associated database 22. Examples of suitable RDBMS include IBM's DB2, Oracle Database, Microsoft SQL Server, PostgreSQL, MySQL, and many others.

The RDBMS components include Data Definition Language (DDL) for defining the structure of the database, Data Control Language (DCL) for defining security/access controls, and Data Manipulation Language (DML) for querying and updating data. The system 10 also provides interface drivers, an SQL engine, a transaction engine, a relational engine and a storage engine. The interface drivers are code libraries that provide methods to prepare statements, execute statements, and retrieve results. Suitable examples include ODBC, JDBC, MySQL/PHP, FireBird/Python. The SQL engine interprets and executes the DDL, DCL, and DML statements, and it comprises three sub-components: a compiler, an optimizer, and an executor. The transaction engine ensures that multiple SQL statements either succeed or fail as a group, according to application dictates. The relational engine implements relational objects such as Table, Index, and Referential integrity constraints, and the storage engine stores and retrieves data from secondary storage (i.e., other databases), as well as managing transaction commit and rollback, backup and recovery, and the likes.

With the above system 10 in mind, the method for extraction and analysis of patient encounters from one or more healthcare related information systems may be carried out. The process of extracting valid, previously unknown and potentially useful patterns and information from raw data in large databases is a multi-step, iterative process that involves such tasks as data acquisition, data preparation and cleaning, data extraction, output analysis and review. Each of these tasks is discussed hereafter.

Data Acquisition

The first stage of the process is data acquisition in which data elements of interest are located and extracted. A software application 26 operating on system 10 according to an embodiment of the present invention, hereafter referred to as “UH-SOCRATES”, integrates existing data from healthcare related information systems 13 (FIG. 1) into the database server 16, which in one location is provided as a MySQL database of inpatient and outpatient encounters. In one embodiment, UH-SOCRATES 26 runs on a dedicated Windows-based server behind a firewall of the healthcare organization 13, and is password accessed over the network 19 by the graphical user interface 18. The graphical user interface 18 in one embodiment is provided by a computer 28, a laptop computer and the likes. In one embodiment, the system 10 receives weekly data extracts 20, such as provided as a flat file via FTP. In one embodiment, seven extracts in a text format are provided from four source healthcare related information systems 12 which are transferred to an “Arrivals” folder where they reside until arranged by the importer component 14. In one embodiment, the data provided in the data extracts 15 or 17 are preselected objects pertaining to services provided by a pre-determined selection of physicians e.g., surgeons of the healthcare organized, by department, specialty, etc. In other embodiments, the preselected objects may be any data which can be provided to the system 10 and in which the importer component 14 can arrange according to an associated data model. The database 22 of the server 16 is created and updated by the importer component 14 arranging the data from the extracts according to the schema of the data model 15 pictured in FIG. 2A or the data model 17 pictured in FIG. 2B. Each of the boxes in the schema represents a different data object containing the fields listed. The source systems for providing the various data extracts 20 to the importer component 14 are discussed hereafter.

Source Systems

Although not a complete listing, the following sources or healthcare related information systems 12 can be used to provide the data extracts 20 to the data processing system 10 of the present invention: enterprise systems, revenue cycle/management systems, cost management/information systems, resource scheduling and documentation systems, and the like which are used for e.g., physician billing, organization billing, resource scheduling and documentation, and administration functions.

One suitable enterprise system for use as a data source is GE's Healthcare Systems Centricity Enterprise (formerly IDX Carecast) system, which is used to manage all aspects of the professional revenue cycle, including scheduling, billing, and claims. For example, from GE's Healthcare Systems Centricity Enterprise system, the system can receive two data extracts: IDX_PT and IDX_INV. The IDX_PT data extract includes, for all patients seen by any of the providers of interest, patient identifying information, patient demographic information, and patient contact information. The IDX_INV data extract includes, for all instances where a physician service has been rendered by any of the providers of interest, information identifying the patient, billing physician, date of service, CPT code, associated diagnoses, place of service, referring physician, professional charge, primary insurer of record, payment received and contractual adjustment.

As known, the Current Procedural Terminology (CPT) code set is maintained by the American Medical Association, and is used to describe and communicate uniform information about medical, surgical, and diagnostic procedures performed on patients among physicians, coders, patients, accreditation organizations, and payers for administrative, financial, and analytical purposes. It is to be appreciated that each record/line in the IDX_INV data extract represents a distinct CPT code such that a given patient could have numerous lines representing different professional services rendered in a single visit.

One suitable revenue cycle/management system for use as a data source is Siemen's Soarian® Financial system which features a contract engine, an enterprise-wide master person index (EMPI), a claims engine, and a denial management engine. For example, from Siemens Soarian® Financial system, the system can receive three data extracts: one for diagnoses (DSS_DX), one for procedures (DSS_PROC), and one for patient accounts (DSS_VISIT).

The DSS_DX extract contains a record for every discharge diagnosis coded within financial system for patients seen by providers of interest. Fields include patient name/MRN, ICD-9 diagnosis code, and date of diagnosis. Primary diagnoses are denoted by a 1 in a diagnosis code priority field.

The DSS_PROC extract contains a record for every procedure performed during a patient encounter. Procedures are coded in terms of ICD-9, volume 3 procedure codes. Also included are identifying patient information, procedure date, and the name and physician ID of the physician performing the procedure.

The DSS_VISIT extract contains a record for every patient account number. A patient account number will often represent a single inpatient stay, or a cluster of related outpatient visits. In one embodiment, financial information extracted from cost management/information (discussed hereafter) is used to identify a patient encounter and the associated length of stay. The DSS_VISIT extract contains identifying patient information, information on admission and discharge dates (though these cannot be relied on because of the issue just described), admitting provider, discharging provider, primary care physician, referring physician, and the likes.

One suitable cost management/information system for use as a data source is Eclipsys' Sunrise EPSi™ system which provides strategic planning, product line budgeting, cost accounting, and operational and capital budgeting of the healthcare organization. For example, from Eclipsys' Sunrise EPSi™ system, the system can receive a data extract which contains technical charge, cost, reimbursement, and projected revenue information for each patient encounter (in-patient, out-patient, or combinations thereof) occurring at the healthcare organization. Cost data can be broken into categories of pharmacy, laboratory, imaging, nursing, etc. In addition, the data extract received from this system may provide one record per encounter (outpatient visit/surgery or in-patient admission) containing identifying patient information, aggregate technical costs, projected revenue, reimbursement, and attending physician ID number.

One suitable resource scheduling and documentation system for use as a data source is PICIS' OR Manager system, which is used in the operating rooms of healthcare organizations to record critical data on all procedures including patient identifying information, time in room, time of incision, time of closure, time out of room, emergency status, pre-operative/post-operative diagnoses, Anesthesiological Society of America (ASA) Score (reflects patient's short-term risk for mortality), and other data relating to medical procedures. It is to be appreciated that PICIS procedure codes are proprietary and do not relate to any standard procedural coding system such as CPT of ICD-9 volume 3. However, it is understood that at some point in the future, PICIS OR Manager will begin using CPT codes, which should better facilitate linking data across systems. OR Manager also contains detailed data on the quantity and unit prices of disposable operating room supplies and implants, which may also be provided in the data extract for use by the system 10.

Data Preparation and Cleaning

Routinely collected clinical data often is full of errors and incomplete, and will need to be prepared properly and cleaned. For example, data cleaning may be needed when error messages occur resulting from data relationships that cannot be processed by the system.

Data Extracts Via Querying

In the illustrated example, the MySQL database 22 constructed by the UH-SOCRATES application from the source data extracts 20 can be queried in two distinct ways, either interactive queries or pre-defined queries, via the graphical user interface 18 which is best depicted by FIGS. 3A-D. With interactive queries, a user can build a query using the graphical user interface 18, for example, searching either by visits (returning only visits matching search criteria) or by patients (returning all patient data, including all visits, for individuals with a visit matching search criteria). In a non-limiting example, for an individual visit, one can view screens containing information in the following categories: physicians connected with the visit, procedures performed as part of the visit, OR utilization or hospital stays associated with the visit, diagnoses, and financial information. The last includes data on aggregate costs, projected revenue, and reimbursement. In one embodiment, all visits or patients matching search criteria can be exported in .csv format, and in other embodiments, any other suitable data format can be used. In this example, the result will be a “flat” file containing select fields from the database. The unit of records in this file is the code. For each ICD-9, CPT code, or PICIS procedure code in the database, there is a record. As a result, a single patient encounter will usually be represented by numerous lines of data. The entries for most fields in each of these records will be identical for a patient encounter (e.g. name, medical record number, dates, insurer, etc.).

The pre-defined queries which in one embodiment are designed by a standardized report 24 may also be selected from the graphical user interface 18. The various standardized reports are discussed hereafter with reference to the next process, output analysis and review.

Output Analysis and Review

In the last process, after an interactive query or pre-defined query is entered via the graphical user interface 18, the database server 16 processes the query using the relations defined by the data model schema (FIGS. 2A-B) and generates a report based on the requirements of the interactive query or the pre-defined query. In a non-limiting example of the pre-defined query, UH-SOCRATES is capable of generating four types of standardized reports: an Outcomes Reports, a Detailed Outlier Report, Referral Report, and a Volume Report as depicted by FIGS. 4-9. In the illustrated examples, the outcome reports and outlier reports feature an operating room section, a post-operative data section, and a financial data section. In a more specific embodiment, the reports may also be detailed outlier reports for outliers above a certain percentile (e.g., above the 80^{th} percentile), volume reports, or referral reports. The reports may be portrayed in a risk-adjusted manner, adjusting risk by level of APR-DRG or comorbidity index. These reports may include information relating to time in the operating room; the length of a hospital stay; cost information, volume information, referral information, and tracking information.

In one embodiment, an open-source report-generating application known as BIRT (Business Intelligence and Reporting Tools) is used to create the reports. In one embodiment, the querying capabilities of BIRT itself can be used to retrieve data from the database of the database server to populate the reports. In another embodiment, system 10 can calculate a Charlson Comorbidity Index, a commonly used score reflecting the extent of patient comorbidity (i.e. co-existing diseases such as coronary artery disease and chronic obstructive pulmonary disease), based on the arranged data and provided as a report.

In other embodiments, the severity adjustment capabilities can be enhanced by using All Patient Refined Diagnosis Related Group (APR-DRG) severity weights used in the APR-DRG application by 3M Corporation. APR-DRG severity weights modify the Center for Medicare and Medicaid Services (CMS) Diagnosis Related Group (DRG) classification system for prospective payment of inpatient services. A severity of illness (SOI) score is assigned to each of the over five hundred DRG categories. SOI scores typically range from one to four in increasing severity, and are dependent on the DRG classification. For example, a patient may be discharged from the hospital with an associated DRG category of 555 and an SOI score of 3. Because SOI scores denote the severity of illness only within a given DRG classification, SOI scores cannot be easily compared across different DRG categories.

In addition to SOI scores, relative weights are also associated with a DRG category. Relative weights provide a measure of a patient's resource requirements, relative to an average patient. For example, a relative weight of 1.0 is typically used to denote the average amount of resources that are utilized within a given DRG category. Variations from the 1.0 average denote an increase or decrease in the amount of resources required by the patient and may be based on factors specific to the patient, including individual risk factors, the circumstances of the current admission, the age of the patient, and comorbidities. By way of example, an individual having an associated relative weight of 1.35 is expected to utilize 35% more resources than the average inpatient. Unlike SOI scores, which depend on their associated DRG categories, relative weights are comparable across different categories (e.g., a relative weight of 1.35 always indicates a 35% greater than average resource utilization, regardless of DRG category).

System 10 may utilize relative weights to generate adjusted cost or adjusted length of stay (LOS) estimates. For example, patients utilizing a higher than average level of resources may be assigned an adjusted cost or length of stay that is lower than the corresponding unadjusted figure. The following equation may be used to adjust the cost or LOS estimates:

$$AdjustedFigure = \frac{UnadjustedFigure}{RelativeSeverityWeight}$$

System 10 may adjust the cost or LOS estimates for an individual inpatient encounter or for a group of encounters, regardless of whether patients were assigned to the same DRG classification. System 10 may then provide the adjusted cost and LOS estimates as part of a generated report.

It is to be appreciated that each query can involve specifying each of the following:

Searching entity—What will be searched for (what will a record in the raw result set represent), procedure, encounter, patient, or physician;

Search criteria—The options available would depend on the searching entity specified above, but can include procedure code, diagnosis code, DRG, patient demographics, dates, MRN/patient name, and provider;

Sorting scheme—How the raw result set should be sorted;

Aggregating entity—How any aggregation of raw results should occur. For example,

Procedures matching search criteria could be aggregated by

Encounter—i.e. One line per encounter in which the procedures matching search criteria were performed

Patient—i.e. One line per patient who has had a procedure matching criteria

Physician (or groups of physicians)—i.e. one line per physician who has performed one or more procedures matching search criteria

Result set could be left disaggregated for export as dataset;

Output elements—What data elements should be reported and, when results are aggregated, how certain data elements should be summarized (N, sum, mean, median, etc.); and

Incorporate itemized cost data reflecting

Costs in different utilization categories such as diagnostic imaging, laboratory, nursing, operating room, etc.,

Disposable supply and implant use in the operating rooms.

In still other embodiments, capabilities which more closely examine certain processes of care (e.g., was the correct antibiotic started and stopped at the correct time perioperatively? Was appropriate prohylaxis against venous thromboembolism employed? Were proper steps taken to control blood glucose perioperatively?), can be provided by linking with (at a minimum) a computerized physician order entry system, and a computerized medication administration records system as other source for data extracts.

Some of the Noted Features:

The system 10 provides the capability to search patients, encounters, and groups of encounters by: Procedure; Diagnosis; Date; Provider; Division; and Department. The data extracts provide information related to a group of designated physicians/providers of interest, and to general surgery. The reporting capabilities help a user to answer question such as “Which care pathways had shortest length of stay in 2008?”, “What proportion of endarterectomy patients are being re-admitted within 30 days of discharge?”, and “Which procedures are being performed cost effectively?”

Some of the other noted features of the various embodiments of the invention are as follows.

User Experience

Users use their network sign-on to access the application. After the signing in, the graphical user interface of the application is presented to the user. In the graphical user interface, the following can be provided.

‘Building Queries’ Tab

Each query involves specifying each of the following:

“Search for . . . ”—What will a record in the results output represent? On the interface, this could be specified using a dropdown menu with options

Distinct billable services (Results would have one record per procedure code)

Procedures (One record per procedure; may include multiple procedure codes.)

Encounters (One record per admissions or outpatient visit)

Patients (One record per patient)

Physicians (One record per physician)

Search criteria—

A query form consists of fields for each of the following. Each field could be entered as free text (except for department and division fields) with capability to use wildcards (*) and Boolean operators. A blank for any field implies a *. An AND operator is implicit between each of the search fields below.

CPT procedure code

Physician (searchable by UH provider number, national physician identifier, or name)

Department (pull down menu)

Division (pull down menu)

procedure date (before, between, or after)

ICD9 procedure code

Physician (searchable by UH provider number, national physician identifier, or name)

Department (pull down menu)

Division (pull down menu)

procedure date (before, between, or after)

ICD9 diagnosis code

Diagnosis-related group (DRG)

Admitting/discharging physician (searchable by UH provider number, national physician identifier, or name)

Department (pull down menu)

Division (pull down menu)

Referring physician (searchable by UH provider number, national physician identifier, or name)

Admission date (before, between, or after)

Discharge date (before, between, or after)

Patient date of birth (before, between, or after)

Patient gender

Discharge status

Medical Record Number (MRN)

Patient name

Selecting Output Elements—

Creating selection list of data elements to be reported

Here, a dropdown list would show an alphabetized list of all fields available in the results dataset. The user could highlight desired fields and click an ‘add’ button to add them to the bottom of a list of fields (a ‘remove’ button could remove choices from this selection list). Two additional buttons would allow the user to ‘add all’ or ‘remove all’ from the selection list.

The user could then highlight fields in the selection list and use ‘move to top’, ‘move up’, ‘move down’, and ‘move to bottom’ buttons to specify the desired order of output elements. This order would correspond to the left-to-right order of column headings in the final output.

The precise output elements available for selection would depend on the level selected in the first step (i.e. reporting by billable service, procedure, encounter, patient, or physician). When multiple records would be represented in a single output field, continuous variables would be represented by means and/or medians. Dichotomous variables would be represented by proportions. Constant variables (e.g. date of birth) would be represented by the constant value. Variables with none of these characteristics would be ‘grayed out’ in the menu of possible output elements.

Saving queries—The user would have the option of saving the above-specified parameters by assigning a unique query name. This could serve as the basis for customized reports. A library of useful shared queries could be established and maintained by the system administrator (these could take the place of the current ‘canned’ reports).

Query results

Query results would appear in a window in which each column could be sorted in ascending or descending order by clicking the column heading.

For results at the distinct billable service or procedure level, each amount for operating room costs would be a link. If clicked, this link would open a separate window showing itemized cost data with one line per chargeable item or implant from the PICIS system. Fields featured would be pre-set as description, catalog number, quantity used, quantity wasted, unit cost, total wastage cost, total cost.

Exporting—If desired, the query results could be exported in any of the below formats. Any post hoc sorting of results would be preserved in the export.

.xls (2003 and 2007)

.csv

.txt

.pdf—Include formatted tables, shading, logo, copyright, etc.

‘Modify query’ button—On any results screen, the user should have an option to return to the screen where they specified search and output criteria. The user's most recent choices should still populate the form. Therefore, it will also be preferred to have a ‘clear form’ button on the search criteria page.

‘Standard Reports’ Tab

A library of useful saved queries could be established by the administrator. Each of these saved queries could be given a report title. Instead of bringing the user to a pre-populated page showing all search options, clicking a standard report option would prompt the user to enter only the information designated as necessary by the administrator (See ‘Administrative features’ section).

A ‘Modify query’ button on the report request form could take the user to the detailed query screen where they could change search/output options specified in the standard report.

As mentioned above, severity adjustment can be provided by using APR-DRG weighting. In addition to operative time and length of stay, severity adjusted operative time and length of stay are among the possible output elements. This data is available in Soarian. These severity-adjusted fields can therefore be created from a simple calculation using available fields.

Administrative features

Levels of access

Currently, one level of user access is sufficient in which any user may see any data at any level. However, in other embodiments, a more restrictive level of access designed for rank and file physicians who would like to look at their own data can be provided. In such an embodiment, users would not be able to view other individuals' data at the individual level, but would be able to compare their numbers to aggregate statistics based on other physicians in the database.

Creating standard reports

On the page where specific query and output selections are made, the administrator would have an additional button: ‘Save as Report’. By clicking this button, the administrator could save the existing query as a named report. Another button would become active on the query screen: ‘Designate user-supplied fields’. Clicking this button would take the administrator to a list of all the search criteria from the query form. The administrator could select one or more of these which he/she would like the user to be prompted for upon requesting a report. For instance, in a report designed to compare different physicians in terms of length of stay for a certain procedure, the user might be prompted to enter the procedure CPT code. Everything else in the resulting query would be pre-set by the administrator as part of the saved report.

On the page where reports may be requested by users, the administrator would have an additional button: ‘Edit report’ which would allow the users to change the report parameters on the page with query/output selections.

FIG. 10 is a flowchart representing one example of a method 100 for extraction and analysis of patient encounters from one or more healthcare related information systems of a healthcare organization. The method 100 can be implemented by computer-executable instructions (e.g., a program) stored on non-transitory computer-readable media or conveyed by a data signal of any type. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). Examples of data signals include electric signals, optical signals, and electromagnetic waves. The data signals can provide the program to a computer via a wired communication line (e.g. electric wires, optical fibers, etc.) or a wireless communication line (e.g., Wi-Fi, cellular, satellite, etc.). When embodiment in a non-transitory computer readable medium, the stored instruction when executed by a processor of a computer causes the computer to execute automatically the processing steps of the method 100 disclosed hereinafter. Also, it is to be appreciated that the processing steps according method 100 can be implemented in cooperation with an operating system (OS) or application software running on a computer and/or on any computer/server in a computer network, in response to an instruction from the program. However, it is to be appreciated that some of the processing steps of the method 100 can be implemented at least in part manually.

At step 102, a data processing system is provided, such as data processing system 10. In step 104, the data processing system receives data from the one or more healthcare related information systems about a plurality of pre-selected objects concerning the patient encounters of the healthcare organization. In step 106, the data processing system arranges said data according to a data model, such as data model 15 or data model 17, which sets relations between the pre-selected objects. In step 108, the data processing system provides a graphical user interface, such as graphical user interface 18, which accepts a query on the arranged data in step 108. In step 110, the data processing system employs the relations between the pre-selected objects to provide a report, such as any of the reports depicted by FIGS. 4-9, to the accepted query. Finally, in step 112, the data processing system outputs the report via the graphical user interface.

The method embodiments of the subject invention may operate in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents. One or more components may reside within a process and/or thread of execution and a component may be localized on one computer and/or distributed between two or more computers.

In order to provide a context for the various aspects of the invention, FIGS. 11 and 12 as well as the following discussion are intended to provide a brief, general description of a suitable computing environment in which the various aspects of the user interfaces, methods and systems described herein may be implemented. Although the description above relates to the general context of computer-executable instructions of a computer program that runs on a computer and/or computers, those skilled in the art will recognize that the user interface, methods and systems also may be implemented in combination with other program modules. Generally, program modules include routines, programs, components, data structures, etc. that performs particular tasks and/or implement particular abstract data types.

Moreover, those skilled in the art will appreciate that the user interfaces, methods and systems described herein may be practiced with other computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. Where computers are linked through a communications network, program modules may be located in both local and remote memory storage devices. The user interface, methods and systems described herein may be embodied on a computer-readable medium having computer-executable instructions for implementing various aspects of the subject invention as well as signals manufactured to transmit such information, for instance, on a network.

FIG. 11 schematically illustrates an exemplary environment 1010 for implementing various aspects of the subject invention. The environment 1010 includes a computer 1012, which includes a processing unit 1014, a system memory 1016, and a system bus 1018. The system bus 1018 electrically couples communicatively various system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 10-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and Rambus Direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 11 illustrates, for example a disk storage device 1024. Disk storage device 1024 includes, but is not limited to, devices like a magnetic disk drive, floppy disk drive, tape drive, Jaz drive, Zip drive, LS-100 drive, flash memory card, or memory stick. In addition, disk storage device 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

In addition to hardware components, FIG. 11 illustrates software that acts as an intermediary between users and the basic computer resources described in suitable operating environment 1010. Such software includes an operating system 1028. Operating system 1028, which can be stored on disk storage devices 1024, acts to control and allocate resources of the computer system 1012. System applications 1030 take advantage of the management of resources by operating system 1028 through program modules 1032 and program data 1034 stored either in system memory 1016 or on disk storage devices 1024. The subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 12 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the user interfaces, methods and systems described herein. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 can connect to one or more client data store(s) 1160 that can be employed to store information local to the client(s) 1110. Similarly, the server(s) 1130 can connect to one or more server data store(s) 1140 that can be employed to store information local to the servers 1130.

What has been described above are examples of the subject invention. It is, of course, not possible to describe every conceivable combination of components or methodologies, but one of ordinary skill in the art will recognize that many further combinations and permutations of the subject invention are possible. Accordingly, the subject invention is intended to embrace all such alterations, modifications and variations that fall within the spirit and scope of the claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for extraction and analysis of patient encounters from one or more healthcare related information systems of a healthcare organization, comprising:
providing a data processing system,
said data processing system:
receiving data from the one or more healthcare related information systems about a plurality of pre-selected objects concerning the inpatient and outpatient encounters of the healthcare organization,
arranging said data according to a data model which sets relations between the pre-selected objects,
providing a graphical user interface which accepts a query on the arranged data,
employing the relations between the pre-selected objects to provide a report to the accepted query in a risk-adjusted manner, and permitting evaluation of outliers within cohorts, and
outputting the report via the graphical user interface.

2. The method according to claim 1, wherein the data processing system is a dedicated Windows-based server running a MySQL database of the inpatient and outpatient encounters.

3. The method according to claim 1, wherein the data is received via FTP.

4. The method according to claim 1, wherein the data is received automatically per a pre-determined time.

5. The method according to claim 1, wherein the data is received as a flat file.

6. The method according to claim 1, wherein the data is for all patients seen by any predetermined provider of interest of the healthcare organization.

7. The method according to claim 6, wherein the data comprises patient identifying, patient demographic information, and patient contact information for all patients seen by any of the predetermined providers of interest.

8. The method according to claim 6, wherein the data comprises, for all instances where a physician service has been rendered by any of the providers of interest, information identifying the patient, billing physician, date of service, associated CPT code, associated diagnoses, place of service, referring physician, professional charge, primary insurer of record, payment received and contractual adjustment.

9. The method of claim 6, wherein the data comprises a record for every discharge diagnosis coded for patients seen by any of the providers of interest.

10. The method of claim 1, wherein the data comprises a record for every medical procedure performed during an encounter.

11. The method of claim 1, wherein the data comprises a record for every patient account number, and wherein the patient account number represents a single inpatient stay, or a cluster of related outpatient visits, and wherein the record contains identifying patient information, information on admission and discharge dates, admitting provider, discharging provider, primary care physician, and referring physician.

12. The method of claim 1, wherein the data comprises financial information, and said method further comprising verifying an encounter and a length of stay at the healthcare organization from the financial information.

13. The method of claim 1, wherein the data comprises technical charge, cost, reimbursement, and projected revenue information for each inpatient or outpatient encounter occurring at the healthcare organization.

14. The method of claim 1, wherein the data comprises pharmacy costs, laboratory costs, imaging costs, and staffing costs for each inpatient or outpatient encounter.

15. The method of claim 1, wherein the data comprises, for each patient encounter, identifying patient information, aggregate technical costs, projected revenue, reimbursement, and attending physician information.

16. The method of claim 1, wherein the data comprises data on all procedures performed in an operating room of the healthcare organization, and includes one or more of patient identifying information, time in room, time of incision, time of closure, time out of room, emergency status, pre-operative/post-operative diagnoses, Anesthesiological Society of America (ASA) Score, quantity and unit prices of disposable operating room supplies and implants, and procedure codes.

17. The method of claim 16, wherein the procedure code are a standard procedural coding system.

18. The method of claim 16, wherein the procedure code is selected from a CPT code set.

19. The method according to claim 1, further comprises selecting the one or more healthcare related information systems from physician billing, organization billing, resource scheduling and documentation, and administration.

20. The method according to claim 1, wherein the pre-selected objects comprises information related to the patient, information related to a visit to the healthcare organization, information related to procedure codes, information related to each physician, information related to stay at the healthcare organization, information related to operation performed, and information related to costs.

21. The method according to claim 1, further comprising providing pre-defined queries which are selected via the graphical user interface.

22. The method according to claim 21, wherein the pre-defined queries are designated by a respective report type and when selected, the respective report type is provided as the report.

23. The method according to claim 22, wherein the respective report type is one of an outcome report showing operating room statistics by physician, an outcome report concerning length of stay and infection rate, outcome report concerning cost, margin, and revenue based on admissions and patients, an identifying outliers report for the operating room statistics, and a tracking volume report for each CPT code, and a tracking volume report for referral volume per provider.

24. A system for extraction and analysis of inpatient and outpatient encounters from one or more healthcare related information systems of a healthcare organization, comprising:
an importer component which receives data from the one or more healthcare related information systems about a plurality of pre-selected objects concerning the inpatient and outpatient encounters of the healthcare organization, and arranges said data according to a data model which sets relations between the pre-selected objects;
a database component which receives the arranged data from the importer component and stores the arranged data in a database; and
a graphical user interface which accepts a query on the arranged data,
wherein the database component employs the relations between the pre-selected objects to provide a report to the accepted query, and outputs the report to the graphical user interface.

25. The system according to claim 24, wherein the database component is a database server.

26. The system according to claim 25, wherein the graphical user interface is provided by a computing device in communication with the database server over a network.

27. The system according to claim 26, wherein the network is selected from a private network, a public network, and a virtual private network.

28. The system according to claim 24, wherein the one or more information system comprises enterprise systems, revenue cycle/management systems, cost management/information systems, resource scheduling and documentation systems, and combinations thereof.

29. A system for the analysis of one or more patient encounters from one or more healthcare related information systems of a healthcare organization, comprising:
a graphical user interface for accepting a query regarding the patient encounters;
an importer component which in response to the query extracts data from the one or more healthcare related information systems about a plurality of pre-selected objects concerning the patient encounters, and arranges said data according to a data model which sets relations between the pre-selected objects; and
a database component that receives the arranged data from the importer component, stores the arranged data in a database, and employs the relations between the pre-selected objects to generate a report to the accepted query.

30. A method for the analysis of one or more patient encounters from one or more healthcare related information systems of a healthcare organization, comprising:
providing a data processing system,
said data processing system:
providing a graphical user interface which accepts a query regarding the patient encounters,
receiving data in response to the query from the one or more healthcare related information systems about a plurality of pre-selected objects concerning the patient encounters,
arranging said data according to a data model which sets relations between the pre-selected objects,
employing the relations between the pre-selected objects to provide a report to the accepted query, and
outputting the report.
